(19) United States
(12) Patent Application Publication
(10) Pub. No.: US 2020/0097908 A1
(43) Pub. Date: Mar. 26, 2020

(54) VEHICULAR IMPLEMENTED DELIVERY

(71) Applicant: INTERNATIONAL BUSINESS MACHINES CORPORATION, Armonk, NY (US)

(72) Inventors: Venita Glasfurd, Chelmsford, MA (US); Sachin Sethiya, Billerica, MA (US)

(21) Appl. No.: 16/140,777

(22) Filed: Sep. 25, 2018

(51) Int. Cl. G06Q 10/08; G06Q 10/04; G06Q 30/02; G01C 21/34; G06F 17/30; G06N 5/04

(52) U.S. Cl. CPC G06Q 10/08355; G06Q 10/047; G06Q 10/087; G06N 5/046; G01C 21/3492; G06F 17/30613; G06Q 30/0202

(57) ABSTRACT

A method and system for automatically implementing a vehicular delivery improvement process is provided. The method includes receiving unstructured data associated with products for delivery via a plurality of vehicles. The unstructured data is stored within a specialized database and analyzed with respect to traffic, weather, and node related data. Predictive modeling software code is generated and executed for determining nodes associated with inventory comprising products for delivery. A ranked list describing the nodes is generated and the plurality of vehicles are directed to the nodes and from the nodes towards delivery locations for delivery of each associated product. An actual time associated with each delivery is determined and the predictive modeling software code is modified resulting in generation of modified predictive modeling software code for refining the ranked list and executing future deliveries of additional products.

### FIELD

The present invention relates generally to a method for implementing a vehicular delivery process and in particular to a method and associated system for coordinating an autonomous delivery process with respect to directing a vehicle to delivery nodes and destinations and modifying predictive modeling software code for executing future deliveries.

### BACKGROUND

Determining object schedules for delivery typically includes an inaccurate process with little flexibility. Coordinating multiple deliveries typically involves an unreliable process. Controlling and directing various delivery processes with respect to objects in need of specialized placement may include a complicated process that may be time consuming and require a large amount of resources. Accordingly, there exists a need in the art to overcome at least some of the deficiencies and limitations described herein above.

### SUMMARY

A first aspect of the invention provides a vehicular implemented delivery improvement method comprising: receiving, by a processor of a controller hardware device, unstructured data associated with products for delivery via a plurality of vehicles; storing, by the processor, the unstructured data within a specialized database; analyzing, by the processor, the unstructured data with respect to traffic, weather, and node related data; generating, by the processor based on results of the analyzing, predictive modeling software code configured to predict a delivery date and minimize a delivery time for the products; determining, by the processor executing the predictive modeling software code, nodes associated with inventory comprising the products for delivery; generating, by the processor executing the predictive modeling software code, a ranked list describing the nodes; directing, by the processor in accordance with the ranked list describing the nodes, the plurality of vehicles to the nodes such that each vehicle of the plurality of vehicles retrieves an associated product of the products; directing, by the processor, the plurality of vehicles from the nodes towards a plurality of delivery locations for delivery of each the associated product; determining, by the processor, an actual time associated with each the delivery; and modifying, by the processor based on each the actual time associated with each the delivery, the predictive modeling software code resulting in generation of modified predictive modeling software code for refining the ranked list and executing future deliveries of additional products.

A second aspect of the invention provides a computer program product, comprising a computer readable hardware storage device storing a computer readable program code, the computer readable program code comprising an algorithm that when executed by a processor of a controller hardware device implements a vehicular implemented delivery improvement method, the method comprising: receiving, by the processor, unstructured data associated with products for delivery via a plurality of vehicles; storing, by the processor, the unstructured data within a specialized database; analyzing, by the processor, the unstructured data with respect to traffic, weather, and node related data; generating, by the processor based on results of the analyzing, predictive modeling software code configured to predict a delivery date and minimize a delivery time for the products; determining, by the processor executing the predictive modeling software code, nodes associated with inventory comprising the products for delivery; generating, by the processor executing the predictive modeling software code, a ranked list describing the nodes; directing, by the processor in accordance with the ranked list describing the nodes, the plurality of vehicles to the nodes such that each vehicle of the plurality of vehicles retrieves an associated product of the products; directing, by the processor, the plurality of vehicles from the nodes towards a plurality of delivery locations for delivery of each the associated product; determining, by the processor, an actual time associated with each the delivery; and modifying, by the processor based on each the actual time associated with each the delivery, the predictive modeling software code resulting in generation of modified predictive modeling software code for refining the ranked list and executing future deliveries of additional products.

A third aspect of the invention provides a controller hardware device comprising a processor coupled to a computer-readable memory unit, the memory unit comprising instructions that when executed by the processor executes a vehicular implemented delivery improvement method comprising: receiving, by the processor, unstructured data associated with products for delivery via a plurality of vehicles; storing, by the processor, the unstructured data within a specialized database; analyzing, by the processor, the unstructured data with respect to traffic, weather, and node related data; generating, by the processor based on results of the analyzing, predictive modeling software code configured to predict a delivery date and minimize a delivery time for the products; determining, by the processor executing the predictive modeling software code, nodes associated with inventory comprising the products for delivery; generating, by the processor executing the predictive modeling software code, a ranked list describing the nodes; directing, by the processor in accordance with the ranked list describing the nodes, the plurality of vehicles to the nodes such that each vehicle of the plurality of vehicles retrieves an associated product of the products; directing, by the processor, the plurality of vehicles from the nodes towards a plurality of delivery locations for delivery of each the associated product; determining, by the processor, an actual time associated with each the delivery; and modifying, by the processor based on each the actual time associated with each the delivery, the predictive modeling software code resulting in generation of modified predictive modeling software code for refining the ranked list and executing future deliveries of additional products.

The present invention advantageously provides a simple method and associated system capable of determining object schedules for delivery.

### BRIEF DESCRIPTION OF THE DRAWINGS

FIG. 1 illustrates a system for implementing an autonomous delivery improvement process with respect to directing a vehicle to delivery nodes and destinations and modifying predictive modeling software code for executing future deliveries, in accordance with embodiments of the present invention.

FIG. 2 illustrates an algorithm detailing a process flow enabled by the system of FIG. 1 for implementing an autonomous delivery improvement process with respect to directing a vehicle to delivery nodes and destinations and modifying predictive modeling software code for executing future deliveries, in accordance with embodiments of the present invention.

FIG. 3 illustrates the software of FIG. 1 for implementing an autonomous delivery improvement process, in accordance with embodiments of the present invention.

FIG. 4 illustrates a detailed view of the system of FIG. 1 for implementing an autonomous delivery improvement process, in accordance with embodiments of the present invention.

FIG. 5 illustrates a computer system used by the system of FIG. 1 for enabling a process for implementing an autonomous delivery improvement process with respect to directing a vehicle to delivery nodes and destinations and modifying predictive modeling software code for executing future deliveries, in accordance with embodiments of the present invention.

FIG. 6 illustrates a cloud computing environment, in accordance with embodiments of the present invention.

FIG. 7 illustrates a set of functional abstraction layers provided by cloud computing environment, in accordance with embodiments of the present invention.

### DETAILED DESCRIPTION

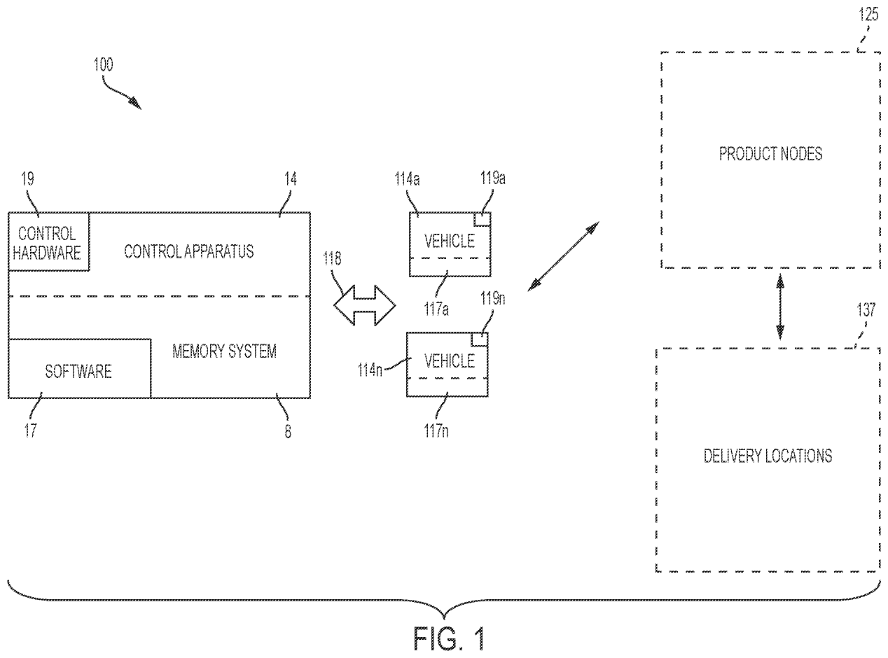

FIG. 1 illustrates a system 100 for implementing an autonomous delivery improvement process with respect to directing a vehicle to delivery nodes and destinations and modifying predictive modeling software code for executing future deliveries, in accordance with embodiments of the present invention. Entities typically attempt to provide accurate expedited shipping with respect to delivering products in a timely manner thereby incurring expedited shipping rate and/or incorrect utilization of inventory. Therefore, system 100 enables a process for providing same day delivery to a user via usage of retail entities located within a vicinity of an order address. System 100 executes cognitive insight code for dynamically learning and ranking the retail entities based on, inter alia, traffic conditions, weather conditions, processing expenses, inventory levels, etc. The cognitive insight code enables a process for selecting a retail entity and ensuring that an order reaches a customer within a specified time window such that retail entities may enable a fulfillment network of stores to support same day or hourly deliveries with a higher degree of accuracy with respect to delivery time predictions. For example, when a customer places an order, system attempts to fulfill the order based on an availability of the ordered products. Additionally, system 100 invokes an optimization algorithm (i.e., via execution of specialized software code that provides an optimal solution associated with ensuring that an order may be delivered to customer within given time window while still ensuring that inventory levels are not over consumed.

The following implementation process details a method for generating a graphical user interface (GUI) associated with implementing an autonomous delivery improvement process:

The process is initiated when retail suppliers that have inventory to fulfill a portion of an order are identified. In response, a delivery model (and associated software code) minimizing a delivery time is generated. The delivery model is associated with the following constraints: historical delivery times associated with a given retail supplier, historical delivery times associated with a given retail supplier, a predicted processing time for each retail supplier, a cut off time for each retail supplier, a known traffic situation in a vicinity of a given retail supplier, a predicted traffic situation within a vicinity of a given retail supplier, predicted weather conditions for a given delivery route to be traversed, known weather conditions for a given delivery route to be traversed, a predicted level of retail supplier sales (at a physical retail location) for a given period of time, predicted online demand for a product included in the portion of the order, etc. In response to execution of the delivery model, a ranked list of retail suppliers is generated. The ranked list is associated with a time frame for shipping the order. Additionally, ranking scores (of the ranked list) are generated for each retail supplier. The ranking scores represent a degree of confidence associated with the order reaching a customer within the specified time. A retail supplier may be selected based on a placement of the retail supplier within the ranked list of retail suppliers. Additionally, a specialized GUI is generated based on the selection of the retail supplier. The specialized GUI is configured to present: the selection of the retail supplier, the portion of the order to be fulfilled by the retail supplier, and an estimated time of shipping for the portion of the order.

System 100 of FIG. 1 includes a control apparatus 14 in communication with vehicles 114a . . . 114n via a wireless network 118. Vehicles 114a . . . 114n comprise software 117a . . . 117n including specialized software scripts for executing an autonomous delivery improvement process with respect to directing vehicles 114a . . . 114n to product nodes 125 (e.g., warehouses storing products for delivery) and delivery (destinations) locations 137 (homes and businesses ordering products) and modifying predictive modeling software code for executing future deliveries. Vehicles 114a . . . 114n (i.e., control hardware 119a . . . 119n internal to vehicles 114a . . . 114n) and control apparatus 14 each may comprise an embedded computer. An embedded computer is defined herein as a remotely portable dedicated computer comprising a combination of computer hardware and software (fixed in capability or programmable) specifically designed for executing a specialized function. Programmable embedded computers may comprise specialized programming interfaces. Additionally, vehicles 114a . . . 114n (i.e., control hardware 119a . . . 119n internal to vehicles 114a . . . 114n vehicles) and control apparatus 14 may each comprise a specialized hardware device comprising specialized (non-generic) hardware and circuitry (i.e., specialized discrete non-generic analog, digital, and logic based circuitry) for executing a process described with respect to FIGS. 1-3. The specialized discrete non-generic analog, digital, and logic-based circuitry may include proprietary specially designed components (e.g., a specialized integrated circuit designed for only implementing an autonomous delivery improvement process with respect to directing vehicles 114a . . . 114n to product nodes 125 and delivery (destinations) locations 137 and modifying predictive modeling software code for executing future deliveries. Control apparatus 14 includes a memory system 8, software 17, and control hardware 19 (all sensors and associated control hardware for enabling software 17 to execute a process for coordinating vehicles 114a . . . 114n for implementing an autonomous delivery improvement process). Control hardware 119a . . . 119n includes sensors. Sensors may include, inter alia, GPS sensors, video recording devices, audio enabled devices (i.e., including speakers and microphones), optical sensors, weight sensors, etc. The memory system 8 may include a single memory system. Alternatively, the memory system may include a plurality of memory systems. Each of vehicles 114a . . . 114n may comprise any vehicle that does not require a human operator to be located within the vehicles 114a . . . 114n such as, inter alia, a remote controlled vehicle (e.g., an aircraft flown by a pilot at a ground control station), an autonomously controlled vehicle (e.g., an aircraft controlled based on pre-programmed flight plans which may include an intelligence algorithm that would enable vehicles 114a . . . 114n to know the aircraft's location and self-determine an item delivery route), a pre-programmed vehicle, etc. Alternatively, vehicles 114a . . . 114n may comprise any type of vehicle that includes a human operator located within the vehicle (e.g., an aircraft, an automobile, a boat or ship, a train, etc.). Vehicles 114a . . . 114n may include, inter alia, an aerial vehicle, a land based vehicle, a marine (water) based vehicle, etc.

System 100 of FIG. 1 enables a vehicle delivery process as follows:

When an order for a product is executed, locations (i.e., product nodes 125) comprising product inventory for fulfilling the order are identified and a model (i.e., specialized computer code) that minimizes a delivery time is generated. The delivery model is associated with the following constraints: historical delivery times associated with a given retail supplier, historical delivery times associated with a given retail supplier, a predicted processing time for each retail supplier, a cut off time for each retail supplier, a known traffic situation in a vicinity of a given retail supplier, a predicted traffic situation within a vicinity of a given retail supplier, predicted weather conditions for a given delivery route to be traversed, known weather conditions for a given delivery route to be traversed, a predicted level of retail supplier sales (at a physical retail location) for a given period of time, predicted online demand for a product included in the portion of the order, etc. The delivery model is executed for generating a ranked list (comprising ranking scores) of product nodes from where the order could be shipped. The ranking scores for each of the product nodes are associated with the aforementioned constraints and represent a degree of confidence associated with the order reaching a customer within the specified timeframe. For example, the model executes a self-learning process based on a selling pattern and current inventory levels of the product, store performance, current traffic conditions and weather conditions to determine if the order may reach the customer within a promised timeframe. If a route to a delivery location is determined to be associated with a high traffic pattern, then the delivery location is ranked with a lower score. Therefore, an order may be shipped to a customer within a same day as a system 100 may be configured to accurately predict when the order will reach the customer. System 100 executes a dynamic rule-based approach for determining a delivery time of an order. For example, system 100 analyzes: an accuracy of a given route, predictions for traffic conditions based on time and day of week, an efficiency of a store to process an order within a stipulated time, an ability for a carrier or delivery service to arrive at a correct time, etc. Therefore, system 100 is configured to train the delivery model with respect to picking, packing, and shipping performance of an associated node to cognitively infer a correct amount of time associated with processing the order.

The following implementation example describes a process for enabling a vehicle delivery process with respect to a distributed network:

The process is initiated when system 100 determines that: an order shipped from a node 1 may reach a customer in 1.5 hours and an order shipped from a node 2 order may reach the customer in 2 hours. Therefore, system 100 may be enabled to deliver the order to the customer in a timely manner based on the aforementioned information. For example, node 1 is initially selected for shipping the order to the customer but as more order are shipped from node 1, node 2 may become a more efficient selection for picking, packing, and shipping the order due to more product being available for shipping. Additionally, during peak hours more alternative routes may be available from node 2 such that order is shipped to the customer in a faster timeframe. Therefore, when a next order is selected for shipping, system 100 analyzes node 2 and determines that node 2 comprises a higher efficiency and is associated with a better traffic route time (than node 1) and therefore node 2 is selected for shipping.

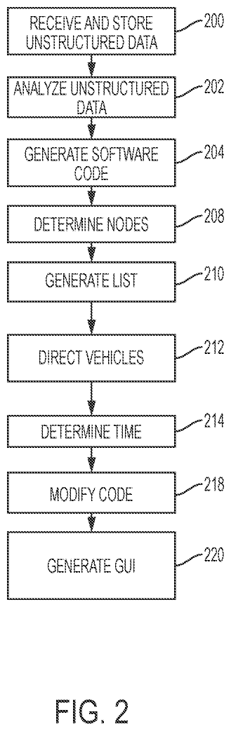

FIG. 2 illustrates an algorithm detailing a process flow enabled by system 100 of FIG. 1 for implementing an autonomous delivery improvement process with respect to directing a vehicle to delivery nodes and destinations and modifying predictive modeling software code for executing future deliveries, in accordance with embodiments of the present invention. Each of the steps in the algorithm of FIG. 2 may be enabled and executed in any order by a computer processor(s) executing computer code. Additionally, each of the steps in the algorithm of FIG. 2 may be enabled and executed in combination by vehicles 114a . . . 114n (i.e., control hardware 119a . . . 119n internal to vehicles 114a . . . 114n) and control apparatus 14 of FIG. 1. In step 200, unstructured data (associated with products for delivery via a plurality of vehicles) is received (by a controller hardware device) and stored within a specialized database. In step 200, the unstructured data is analyzed with respect to traffic, weather, and node related data. In step 204, predictive modeling software code is generated based on the analysis of step 202. The predictive modeling software code is configured to predict a delivery date and minimize a delivery time for the products. Generating the predictive modeling software code may be further based on constraints including: suppliers associated with the nodes, historical delivery times associated with the suppliers, a predicted processing time for each supplier, a cut off time for each supplier, a known traffic situation within a vicinity of each supplier, a predicted traffic situation within said vicinity of each supplier, predicted weather conditions for a specified delivery route to be traversed, known weather conditions for said specified delivery route to be traversed, a predicted level of retail supplier sales (at a physical retail location) for a given period of time, a predicted online demand for a product included within a portion of an order, etc. In step 208, nodes associated with inventory comprising the products for delivery are determined. In step 210, a ranked list describing the nodes is generated. Generating the ranked list is based on: a processing time for each node of the nodes, a cut off time for each node, a traffic situation within a vicinity of each node, and weather conditions associated with a route associated with each node. Additionally, ranking scores for each node may be generated and applied to the ranked list such that each ranking score represents a degree of confidence associated with a delivery time for delivery of each associated product. In step 212, the plurality of vehicles are directed (in accordance with the ranked list) to the nodes such that each vehicle retrieves an associated product for delivery. Subsequently, the plurality of vehicles are directed from the nodes towards a plurality of delivery locations for delivery of each associated product. In step 214, an actual time associated with each delivery is determined. In step 218, the predictive modeling software code is modified (based on results of step 214) resulting in generation of modified predictive modeling software code for refining the ranked list and executing future deliveries of additional products. In step 220, a graphical user interface (GUI) is generated based on a selection of at least one node for delivery of at least one product. The GUI is configured to present a portion of an order to be fulfilled by the at least one node and an estimated time of shipping for a portion of the order. The selection (of the at least one node) may be executed within a first portion of the GUI and results of the selection may be presented within a second portion of the GUI. A content of the first portion and the second portion may be modified based on identification of a customer or nodes such that information included within the content differs based on a type of user accessing the GUI. The selection initiates transmission of an electronic notification including instructional code for shipping the portion of the order to an address specified by a user.

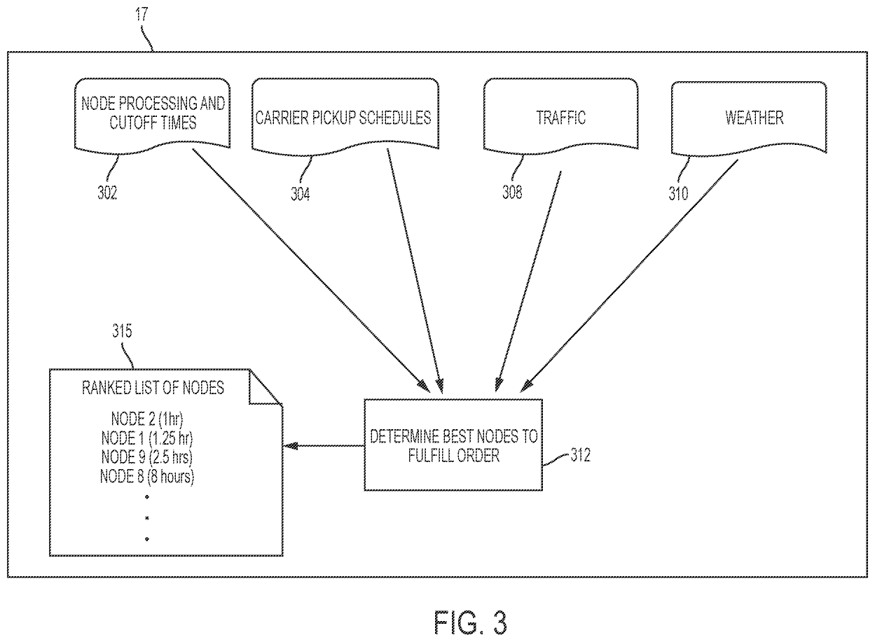

FIG. 3 illustrates software 17 of FIG. 1 for implementing an autonomous delivery improvement process, in accordance with embodiments of the present invention. Software 17 enables a process such that when a customer orders a product, system 100 (of FIG. 1) schedules the order for delivery based on an availability of the product. System 100 invokes an optimization process for providing an optimal solution to ensure that the product may be delivered on a same day as placing the order. Software application comprises retrieved data 302, 304, 308, and 310 (associated with node processing, carrier pickup schedules, traffic conditions, and weather) for input into logic 312 (i.e., for selecting nodes) for generating a ranked list of nodes 315. The ranked list of nodes 315 enables the process for directing a vehicle to delivery nodes and destinations and modifying predictive modeling software code for executing future deliveries.

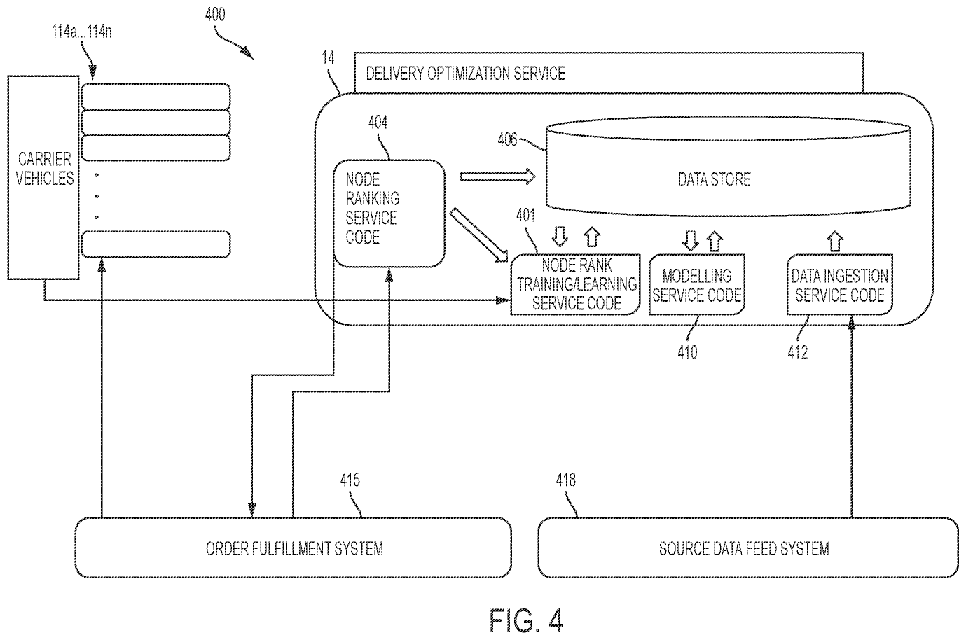

FIG. 4 illustrates a detailed view 400 of system 100 of FIG. 1 for implementing an autonomous delivery improvement process, in accordance with embodiments of the present invention. Detailed view 400 illustrates control apparatus 14 (of FIG. 1) in communication with vehicles 114a . . . 114n (of FIG. 1), an order fulfillment system 415, and source data feed system 418. Control apparatus 14 comprises node ranking service code 404, node rank/learning code 408, modeling service code 410, data ingestion service code 412, and a data store 406. Data ingestion service code retrieves different types of unstructured data via data ingestion service code 412 and transmits the unstructured data to a data store 406. The unstructured data may include, inter alia, store transaction log data, markdown data, fulfillment network data, carrier data, carrier pickup schedule, node data, demand, availability data, etc. Modeling service code 410 is configured to build a predictive model that minimizes a time for delivery. The model analyzes the unstructured data (and additional unstructured data including traffic and weather conditions associated with a route of travel) and generates a probabilistic set of features for minimizing a time for delivering a product from a node to its destination. Additionally, stockout and markdown costs are generated for each combination of product and node. The aforementioned costs are further analyzed with respect to a future ranking phase for ranking nodes and associating a score with each node. Subsequently (when an order comes in for fulfillment) system 100 determines which nodes have the inventory to fulfill the order and transmits the order and associated list of nodes to node ranking service code 404. In response, ranking service code returns a ranked list of nodes from where the product(s) may be shipped from. A generated ranking score for each node is associated with a factor associated with attributes such as, inter alia, processing time for each node, cut off time for each node, a traffic situation within a vicinity of the node, weather conditions for route to traverse), etc. Likewise, system 100 groups the list of orders and products by destination zones and directs carrier vehicles for delivery of the products to a desired destination. Additionally, node rank/learning code 408 enables cognitive learning techniques for refining different ranked lists offers and providing better ranking scores to each node. For example, every time a product is delivered, a message is transmitted to node rank/learning code 408. The message includes an actual time of delivery. An actual time of delivery that falls within a window of a promise date of the product is interpreted as positive reinforcement for training node rank/learning code 408. Likewise, an actual time that does not fall within the window of the promise date of the product is interpreted as a need to improve the prediction of the promise date. In this case, node rank/learning code 408 will train itself by analyzing alternate nodes to provide a better list of ranked nodes during a next iteration thereby allowing for a much more accurate promise date delivery.

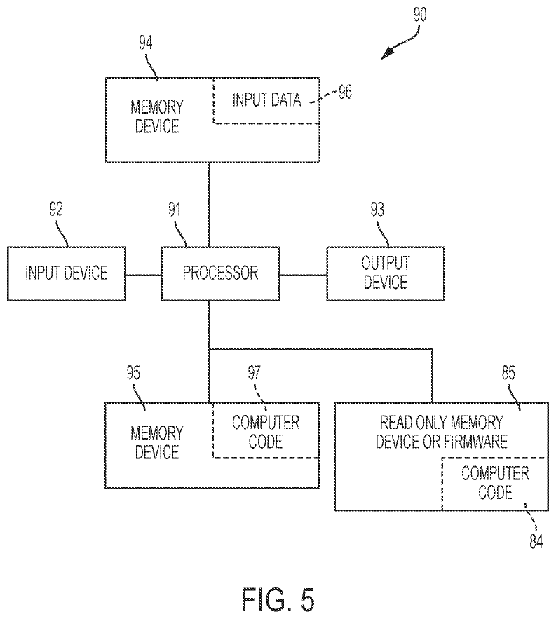

FIG. 5 illustrates a computer system 90 (e.g., control hardware 119a . . . 119n internal to vehicles 114a . . . 114n and control apparatus 14) used by or comprised by the system of FIG. 1 for enabling a process for implementing an autonomous delivery improvement process with respect to directing a vehicle to delivery nodes and destinations and modifying predictive modeling software code for executing future deliveries, in accordance with embodiments of the present invention.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 90 illustrated in FIG. 5 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random-access memory (DRAM), a read-only memory (ROM), etc. The memory device 95 includes a computer code 97. The computer code 97 includes algorithms (e.g., the algorithm of FIG. 2) for enabling a process for implementing an autonomous delivery improvement process with respect to directing a vehicle to delivery nodes and destinations and modifying predictive modeling software code for executing future deliveries. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms (e.g., the algorithm of FIG. 2) and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 84 (e.g., including algorithm) may be stored on a static, nonremovable, read-only storage medium such as a Read-Only Memory (ROM) device 85, or may be accessed by processor 91 directly from such a static, nonremovable, read-only medium 85. Similarly, in some embodiments, stored computer program code 97 may be stored as computer-readable firmware 85, or may be accessed by processor 91 directly from such firmware 85, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to enable a process for implementing an autonomous delivery improvement process with respect to directing a vehicle to delivery nodes and destinations and modifying predictive modeling software code for executing future deliveries. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for implementing an autonomous delivery improvement process with respect to directing a vehicle to delivery nodes and destinations and modifying predictive modeling software code for executing future deliveries. In another embodiment, the invention provides a business method that performs the process steps of the invention on a subscription, advertising, and/or fee basis. That is, a service supplier, such as a Solution Integrator, could offer to enable a process for implementing an autonomous delivery improvement process with respect to directing a vehicle to delivery nodes and destinations and modifying predictive modeling software code for executing future deliveries. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 3. For example, the memory devices 94 and 95 may be portions of a single memory device rather than separate memory devices.

### Cloud Computing Environment

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

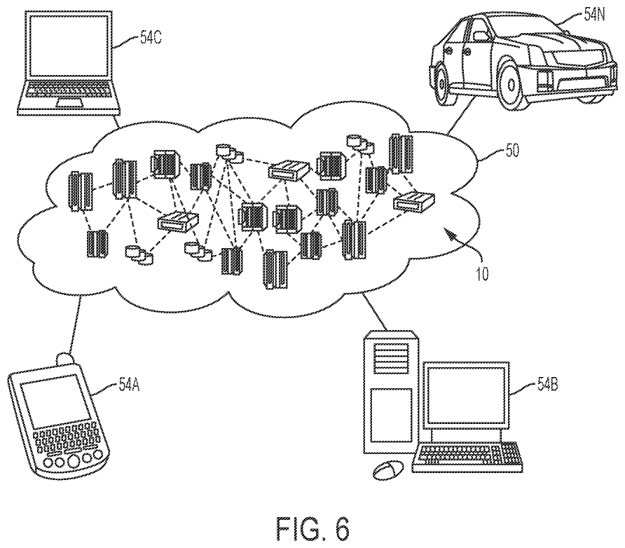

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 6 are intended to be illustrative only and that computing nodes 10 and cloud computing environment 50 can communicate with any type of computerized device over any type of network and/or network addressable connection (e.g., using a web browser).

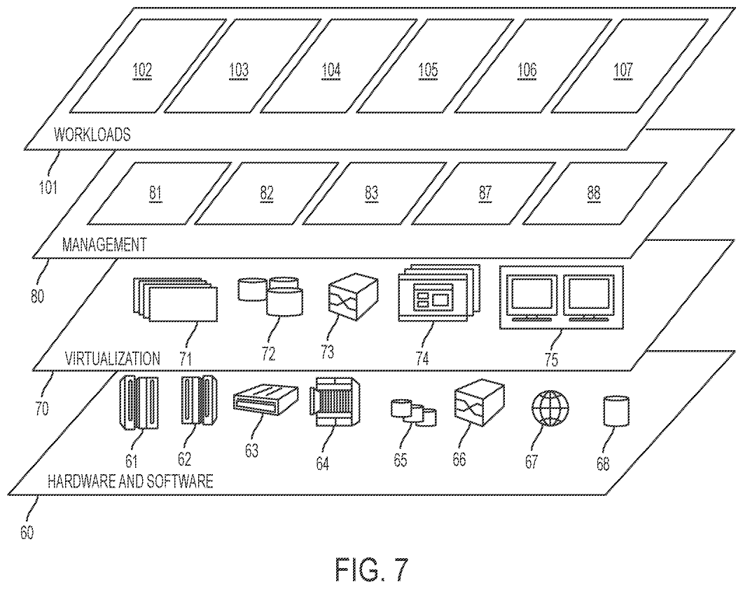

Referring now to FIG. 7, a set of functional abstraction layers provided by cloud computing environment 50 (see FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 101 provides examples of functionality for which the cloud computing environment may be utilized. Examples of workloads and functions which may be provided from this layer include: mapping and navigation 102; software development and lifecycle management 103; virtual classroom education delivery 104; data analytics processing 105; transaction processing 106; and implementing an autonomous delivery improvement process with respect to directing a vehicle to delivery nodes and destinations and modifying predictive modeling software code for executing future deliveries 107.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A vehicular implemented delivery improvement method comprising:
receiving, by a processor of a controller hardware device, unstructured data associated with products for delivery via a plurality of vehicles;
storing, by said processor, said unstructured data within a specialized database;
analyzing, by said processor, said unstructured data with respect to traffic, weather, and node related data;
generating, by said processor based on results of said analyzing, predictive modeling software code configured to predict a delivery date and minimize a delivery time for said products;
determining, by said processor executing said predictive modeling software code, nodes associated with inventory comprising said products for delivery;
generating, by said processor executing said predictive modeling software code, a ranked list describing said nodes;
directing, by said processor in accordance with said ranked list describing said nodes, said plurality of vehicles to said nodes such that each vehicle of said plurality of vehicles retrieves an associated product of said products;
directing, by said processor, said plurality of vehicles from said nodes towards a plurality of delivery locations for delivery of each said associated product;
determining, by said processor, an actual time associated with each said delivery; and
modifying, by said processor based on each said actual time associated with each said delivery, said predictive modeling software code resulting in generation of modified predictive modeling software code for refining said ranked list and executing future deliveries of additional products.

2. The method of claim 1, wherein said generating said ranked list is based on: a processing time for each node of said nodes, a cut off time for each said node, a traffic situation within a vicinity of each said node, and weather conditions associated with a route associated with each said node.

3. The method of claim 1, wherein said generating said predictive modeling software code is further based on constraints selected from the group consisting of suppliers associated with said nodes, historical delivery times associated with said suppliers, a predicted processing time for each supplier of said suppliers, a cut off time for each said supplier, a known traffic situation within a vicinity of each said supplier, a predicted traffic situation within said vicinity of each said supplier, predicted weather conditions for a specified delivery route to be traversed, known weather conditions for said specified delivery route to be traversed, a predicted level of retail supplier sales at a physical retail location for a given period of time, and a predicted online demand for a product included within a portion of an order.

4. The method of claim 1, further comprising;
generating, by said processor, ranking scores for each node of said nodes; and
applying, by said processor, said ranking scores to said ranked list, wherein each ranking score of said ranking scores represents a degree of confidence associated with a delivery time for said delivery of each said associated product.

5. The method of claim 1, further comprising;
generating, by said processor based on a selection of at least one node of said nodes for delivery of at least one product of said products, a graphical user interface (GUI) presenting a portion of an order to be fulfilled by said at least one node and an estimated time of shipping for said portion of said order.

6. The method of claim 5, wherein said selection is executed within a first portion of said GUI, wherein results of said selection are presented within a second portion of said GUI, and wherein a content of said first portion and said second portion is modified based on an identification of a customer or said nodes such that information included within said content within said first portion and said second portion differs based on a type of user accessing said GUI.

7. The method of claim 6, wherein said selection initiates transmission of an electronic notification including instructional code for shipping said portion of said order to an address specified by a user.

8. The method of claim 1, further comprising:
providing at least one support service for at least one of creating, integrating, hosting, maintaining, and deploying computer-readable code in the control hardware, said code being executed by the processor to implement: said receiving, said storing, said analyzing, said generating, said determining said nodes, said directing said plurality of vehicles to said nodes, said directing said plurality of vehicles from said nodes, said determining said actual time, and said modifying.

9. A computer program product, comprising a computer readable hardware storage device storing a computer readable program code, said computer readable program code comprising an algorithm that when executed by a processor of a controller hardware device implements a vehicular implemented delivery improvement method, said method comprising:
receiving, by said processor, unstructured data associated with products for delivery via a plurality of vehicles;
storing, by said processor, said unstructured data within a specialized database;
analyzing, by said processor, said unstructured data with respect to traffic, weather, and node related data;
generating, by said processor based on results of said analyzing, predictive modeling software code configured to predict a delivery date and minimize a delivery time for said products;
determining, by said processor executing said predictive modeling software code, nodes associated with inventory comprising said products for delivery;
generating, by said processor executing said predictive modeling software code, a ranked list describing said nodes;
directing, by said processor in accordance with said ranked list describing said nodes, said plurality of vehicles to said nodes such that each vehicle of said plurality of vehicles retrieves an associated product of said products;
directing, by said processor, said plurality of vehicles from said nodes towards a plurality of delivery locations for delivery of each said associated product;
determining, by said processor, an actual time associated with each said delivery; and
modifying, by said processor based on each said actual time associated with each said delivery, said predictive modeling software code resulting in generation of modified predictive modeling software code for refining said ranked list and executing future deliveries of additional products.

10. The computer program product of claim 9, wherein said generating said ranked list is based on: a processing time for each node of said nodes, a cut off time for each said node, a traffic situation within a vicinity of each said node, and weather conditions associated with a route associated with each said node.

11. The computer program product of claim 9, wherein said generating said predictive modeling software code is further based on constraints selected from the group consisting of suppliers associated with said nodes, historical delivery times associated with said suppliers, a predicted processing time for each supplier of said suppliers, a cut off time for each said supplier, a known traffic situation within a vicinity of each said supplier, a predicted traffic situation within said vicinity of each said supplier, predicted weather conditions for a specified delivery route to be traversed, known weather conditions for said specified delivery route to be traversed, a predicted level of retail supplier sales at a physical retail location for a given period of time, and a predicted online demand for a product included within a portion of an order.

12. The computer program product of claim 9, wherein said method further comprises:
generating, by said processor, ranking scores for each node of said nodes; and
applying, by said processor, said ranking scores to said ranked list, wherein each ranking score of said ranking scores represents a degree of confidence associated with a delivery time for said delivery of each said associated product.

13. The computer program product of claim 9, wherein said method further comprises:
generating, by said processor based on a selection of at least one node of said nodes for delivery of at least one product of said products, a graphical user interface (GUI) presenting a portion of an order to be fulfilled by said at least one node and an estimated time of shipping for said portion of said order.

14. The computer program product of claim 13, wherein said selection is executed within a first portion of said GUI, wherein results of said selection are presented within a second portion of said GUI, and wherein a content of said first portion and said second portion is modified based on an identification of a customer or said nodes such that information included within said content within said first portion and said second portion differs based on a type of user accessing said GUI.

15. The computer program product of claim 14, wherein said selection initiates transmission of an electronic notification including instructional code for shipping said portion of said order to an address specified by a user.

16. A controller hardware device comprising a processor coupled to a computer-readable memory unit, said memory unit comprising instructions that when executed by the processor executes a vehicular implemented delivery improvement method comprising:
receiving, by said processor, unstructured data associated with products for delivery via a plurality of vehicles;
storing, by said processor, said unstructured data within a specialized database;
analyzing, by said processor, said unstructured data with respect to traffic, weather, and node related data;
generating, by said processor based on results of said analyzing, predictive modeling software code configured to predict a delivery date and minimize a delivery time for said products;
determining, by said processor executing said predictive modeling software code, nodes associated with inventory comprising said products for delivery;
generating, by said processor executing said predictive modeling software code, a ranked list describing said nodes;
directing, by said processor in accordance with said ranked list describing said nodes, said plurality of vehicles to said nodes such that each vehicle of said plurality of vehicles retrieves an associated product of said products;
directing, by said processor, said plurality of vehicles from said nodes towards a plurality of delivery locations for delivery of each said associated product;
determining, by said processor, an actual time associated with each said delivery; and
modifying, by said processor based on each said actual time associated with each said delivery, said predictive modeling software code resulting in generation of modified predictive modeling software code for refining said ranked list and executing future deliveries of additional products.

17. The controller hardware device of claim 16, wherein said generating said ranked list is based on: a processing time for each node of said nodes, a cut off time for each said node, a traffic situation within a vicinity of each said node, and weather conditions associated with a route associated with each said node.

18. The controller hardware device of claim 16, wherein said generating said predictive modeling software code is further based on constraints selected from the group consisting of suppliers associated with said nodes, historical delivery times associated with said suppliers, a predicted processing time for each supplier of said suppliers, a cut off time for each said supplier, a known traffic situation within a vicinity of each said supplier, a predicted traffic situation within said vicinity of each said supplier, predicted weather conditions for a specified delivery route to be traversed, known weather conditions for said specified delivery route to be traversed, a predicted level of retail supplier sales at a physical retail location for a given period of time, and a predicted online demand for a product included within a portion of an order.

19. The controller hardware device of claim 16, wherein said method further comprises:
generating, by said processor, ranking scores for each node of said nodes; and
applying, by said processor, said ranking scores to said ranked list, wherein each ranking score of said ranking scores represents a degree of confidence associated with a delivery time for said delivery of each said associated product.

20. The controller hardware device of claim 16, wherein said method further comprises:
generating, by said processor based on a selection of at least one node of said nodes for delivery of at least one product of said products, a graphical user interface (GUI) presenting a portion of an order to be fulfilled by said at least one node and an estimated time of shipping for said portion of said order.
